(19) United States
(12) Patent Application Publication
(10) Pub. No.: US 2002/0114941 A1
(43) Pub. Date: Aug. 22, 2002

(54) Plastic-bound lightweight materials, method for the production thereof, and composite materials

(76) Inventors: Matthias Franke, Moritzburg (DE); Peter Niedner, Bad Wiessee (DE)

Correspondence Address: MARSHALL, GERSTEIN & BORUN, 6300 SEARS TOWER, 233 SOUTH WACKER, CHICAGO, IL, 60606-6357, US

(21) Appl. No.: 09/956,234

(22) Filed: Sep. 19, 2001

(30) Foreign Application Priority Data
Sep. 19, 2000 (DE) 100 46 298.7

(51) Int. Cl. B32B 3/26

(52) U.S. Cl. 428/320.2; 156/245

(57) ABSTRACT

The present invention relates to lightweight materials which contain lightweight granules, in particular mineral foam granules, and an organic binder, the volume amount of the lightweight granules in the material being at least 50%, and that the components are bound in the material in a structurally dense manner. Furthermore, the invention relates to a method for the production thereof by the following steps: introducing the lightweight granules into a workpiece mold, optionally heating the grain feed of lightweight granules, introducing the binder into the workpiece mold filled with the lightweight granular bulk material, solidifying the binder, and to a composite material containing a core of the lightweight material according to the invention and a surface surrounding the core completely or in part and consisting of steel, stainless steel, fiber laminates or plastics.

The present invention relates to lightweight materials containing lightweight granules, in particular mineral foam granules, and an organic binder. Optionally, additives may be contained in minor amounts. Furthermore, the present invention relates to a method for the production thereof and to a composite material containing the lightweight materials according to the invention.

Lightweight materials are increasingly used in many technical fields. In particular in the traffic sector, e.g. in car manufacturing, they have become widely popular because of their high strength and, in comparison with constructional materials which have so far been in use, because of their low density, for they permit the construction of energy-saving and thus environmentally friendly cars. Of preferred interest are lightweight materials having a density below 1.0 g/m³, which are thus below the density of most plastics.

It is known from the prior art to mix plastics with inorganic components to improve specific characteristics and/or to produce less expensive materials. Fillers, such as chalk, or reinforcing materials, such as glass fibers, are often processed into plastics. However, the density of these known inorganic components is about twice as high as that of the plastic material, so that these are not suited to lower the resulting density of the workpiece consisting of plastics plus inorganic components.

Furthermore, it is known to process plastics with a lightweight fine-grained inorganic component consisting of so-called hollow microspheres. At the present stage of manufacturing technology, however, it is not possible to incorporate high percentages of such components into the plastic material. The achievable volume amount of the hollow microspheres in the workpiece is limited to values below 50% by vol. in structurally dense materials. The density of the resulting lightweight material is therefore high and workpieces made therefrom are too heavy for many applications. Another drawback is that the hollow microspheres are very expensive, which rules out the use of such materials in mass-produced articles. A further drawback is the high amount of plastics which in mass-produced articles also rules out the use of high-quality plastics for economic reasons.

Therefore, it has already been suggested to bind inorganic components with a plastic material not in a structurally dense way, but with a porous bulk material. It has thereby become possible in practice to lower the plastic amount in the material to far less than 50% by vol. However, the strength values in such materials considerably decline in comparison with materials bound in a structurally dense way; that is why they can only be used to a limited degree.

In the prior art, a structurally dense plastic matrix can however not be produced at a very high packing density of e.g. 80% by vol. of lightweight granules. This is due to the fact that in the standard processing methods and under the standard production conditions the lightweight granules always tend to separate, which is accompanied by a decrease in the packing density.

The separation is substantially caused by the difference in density between the lightweight granules and the plastic matrix and, in particular, by the difference in weight between the individual lightweight granular grains having different grain sizes; as a consequence, large-grained lightweight granules “float” during processing, and voids are formed in the lower portion of the workpiece mold and fine-grained lightweight granules accumulate there in addition.

It is further known that instead of plastics a light metal is used as a binder for the inorganic components. Although such a material has turned out to be very suited, its use is limited. These workpieces of ultra-light metal can only be used for special workpieces, e.g. complicated chassis and engine parts, due to the high raw-material prices of light-metal alloys and due to the high processing costs because of the high production temperatures. They are not suited as materials for the bodies and interior trims of automotive vehicles because they are too heavy and cost-intensive.

It has therefore been the object to develop lightweight materials which meet the high technical demands, in particular high strength and ductility, and which moreover are so inexpensive that economic reasons do not exclude their use in mass-produced articles. Their use should not be limited to special applications in car building, e.g. chassis parts in automotive vehicles, but should include stationary traffic means and other applications, e.g. in the building trade and in mechanical engineering.

The above-described object is achieved by lightweight materials which contain lightweight granules, in particular mineral foam granules, and an organic binder. They are characterized in that the volume amount of the lightweight granules in the lightweight material is at least 50% by vol., and that the components are bound in the material in a structurally dense manner.

Preferably, the lightweight materials according to the invention contain at least 80% by vol., and in particular preferably at least 50% by vol., of the lightweight granules.

The lightweight materials according to the invention show a combination of characteristics which could so far not be observed in other materials. Surprisingly, they are characterized by high values of strength, in particular by a very high compressive strength, at an extremely low density. The lightweight materials according to the invention are ductile and in this respect comparable to metals or are even by far superior to them. New and life-saving solutions for casualties have become possible thanks to the use of the lightweight materials according to the invention.

Materials are said to be structurally dense when the lightweight granules are substantially completely embedded in a matrix of the organic binder. Thus the organic binder forms an almost pore-free matrix.

Lightweight granules in the sense of the present invention are flowable, substantially spherical particles. They have a grain size between 0.01-30 mm, preferably 0.04-16 mm, and in particular preferably between 0.2 and 8 mm.

The geometry and size of the lightweight granular particles are of particular importance to the characteristics of the lightweight materials according to the invention. As a rule, the particles may have any desired shape. However, it might then be necessary to put up with a low packing density and a high resulting bulk density of the workpiece. It has turned out to be useful when the lightweight material is built up of highly flowable particles which are predominantly spherical or approximately spherical. Spherical particles have the effect that the lightweight granular bulk material is very densely packed into the workpiece mold after the filling operation has been completed, for in contrast to lightweight granular particles of an undefined shape lightweight granular particles of a spherical shape have excellent bulk flow properties, i.e. the behavior of the lightweight granular bulk material during processing, in particular during filling of the mold of the workpiece, and they form less caverns. A dense packing of the lightweight granules only requires the use of a small amount of binder.

The granules according to the invention have a bulk density of 0.040 kg/l to 0.600 kg/l. Preferably, the bulk density is below 0.300 kg/l. Their open surface porosity is below 15%, preferably below 5%.

The lightweight granules have either closed pores or with special applications have only a small open surface porosity in the range of 1% to 10%, based on the total volume. A possible infiltration of the grain by the binder is limited to said porosity. Furthermore, they have a closed volume porosity, the pores being filled with a gas. As a rule, the pores are very small and have a diameter of less than 1/10, preferably less than 1/50 of the granular size. In particular with very small grain sizes, in particular in the range below 0.2 mm, granules with a single gas bubble, so-called hollow spheres or other hollow spherical shapes, are used according to the invention.

The very high packing density which is desired according to the invention makes high demands on the quality of the lightweight granules. Therefore, for a packing having only one grain size, a relatively high packing density can only be achieved if the individual grains differ in diameter only slightly from the design grain and only deviate from the spherical shape to a small degree.

It has here been found that the demands made on the deviations from the size of the individual grains can best be described by an indicated grain size group. The grain size group specifies the range of the admissible grain sizes because in practice it is impossible to select a single grain size from a grain feed. A selected grain size group must here have a very narrow range of grain sizes (e.g. 4 to 5 mm, 2 to 3 mm), and a tolerance range of ±6% based on the minimum and maximum diameters of the grain groups must at the same time be observed within said grain group to achieve high packing densities. When this range of tolerances is limited to ±4% or less, optimum packing densities are achievable in practice. When the range of tolerances is raised to 10% at the most, satisfactory packing densities can still be achieved. Above 10% the results do not promise the production of high-quality products. The technical classification efforts for the relevant grain groups must be adapted to these requirements.

Preferably, mineral lightweight granules are used for the lightweight material according to the invention; these granules are shaped by pellet formation on a pelletizing table prior to the process step of making them porous, and the granules pass through the porosity-imparting furnace in a feed the maximum height of which is 15 grain diameters. Higher bulk densities during production result in a deformation of the granules, with the consequence that the product has no spherical shape within the tolerance range of the invention. By contrast, granules which are produced in the conventional way by using presses and rollers and/or pass in a higher amount of feed through the furnace show greater deviations.

Furthermore, it has been found that a maximum deviation of the grains from the spherical shape of ±4% of the spherical diameter ensures high packing densities, and deviations in the range of ±8% still guarantee satisfactory packing densities, while deviations of more than ±10% already yield very poor results. Therefore, granules with a maximum deviation of ±8%, preferably ±4%, for the packing are used for the lightweight materials according to the invention.

According to the invention granular grains of a single grain size group are used when modest demands are made on the packing density because of the simpler packing formation.

Furthermore, when higher demands are made on the packing density, it has been found that those spherical lightweight granules are suited that consist of particles having two different grain size groups. Preferred are particle mixtures that contain an amount of at least 60% by vol., preferably at least 70% by vol., of spherical particles of the larger diameter (hereinafter called primary grain) and not more than 40% by vol., preferably not more than 30% by vol., of spherical particles of the smaller diameter (hereinafter called secondary grain), the diameter of the primary grain being 6 to 12 times, preferably at least 10 times, the diameter of the secondary grain.

When very high demands are made on the packing density, use is further made of lightweight materials of the inventive type that contain mixtures of spherical lightweight granules with three different grain size groups. Among these, mixtures of lightweight granules are of particular importance whose largest spherical particles (primary grain) have an amount of at least 50% by vol., whose medium spherical particles (secondary grain) have an amount of not more than 35% by vol., and whose smallest spherical particles (hereinafter called tertiary grain) have an amount of not more than 15% by vol., each based on the mixture of lightweight granules, the diameters of large and medium as well as medium and smallest spherical particles differing from one another by at least 6 to 18 times, preferably 12 times.

Furthermore, mixtures of spherical lightweight granules may be used having more than three different grain sizes (primary grain, secondary grain, tertiary grain, quaternary grain, etc.). It has turned out to be of advantage when microspheres with a diameter between 0.03 and 0.15 mm are used as the smallest grain size and when the grain size grading between the individual fractions from the fraction with the smallest grain diameter to the fraction with the largest grain diameter is each time the same factor with a tolerance of ±20%.

According to the invention lightweight granules of a different material quality are used. For instance, mineral lightweight granules may be used in the novel materials. These include substances with an oxidic and/or mineral composition. The following shall here be named by way of example: alkali silicates, alkali/alkaline-earth silicates, alumosilicates, borosilicates, and further variants in combination with the system CaO—SiO₂—Al₂O₃ plus metal oxides.

Granules consisting of mineral substances, such as aluminum oxide (up to 100% Al₂O₃), such as alkali silicate (up to 100% water glass), or the like, are here preferably used. In alkali silicates, granules of sodium water glass which are stabilized with 4% to 10% zinc oxide and foamed by microwave are preferably used. Such materials are described in detail in German patent application DE 199 09 077.7.

Corresponding mineral lightweight granules are commercially available in grain sizes up to 16 mm and are e.g. obtainable under the names KeraGlas, KeraBims, KeraPlus, KeraLight, Poraver, Liaver, Liapor, Leca and Hollow Spheres.

Furthermore, two or more mineral lightweight granules of different compositions and optionally in different volume amounts can be combined with one another in the packing. For instance, a particularly pressure-resistant mineral primary grain, e.g. from crushed rock foam of basalt, which has a very high strength, can be combined according to the invention with one or more less resistant sub-grains, e.g. from glass foam. According to the invention the material density is additionally reduced by exploiting the lower density of the secondary grain. The fact that the secondary grain is less likely to break than the primary grain because of its smaller dimension in the plastic matrix is here exploited. So-called shell bodies can also be used, preferably as primary grain. They consist of a coarse-pored core and a fine-pored shell or even of a compact pore-free shell which is particularly resistant to breakage. As a result, it is possible to produce materials of a particularly high strength.

Apart from mineral lightweight granules, metallic or other non-mineral substances can also be used as lightweight granules. The following materials are mentioned as examples thereof: ductile metals and plastics of a low open porosity which deform under pressure in the already formed packing, thereby effecting a further increase in the packing density. According to the invention, hollow spheres of metal are particularly suited, in particular when used as primary grain.

According to the invention the individual lightweight granular particles are bonded with the help of an organic binder to obtain a solid body. Suited for such a purpose are different classes of organic compounds in flowable form. The binders can be introduced in solid or liquid form, as a solution or also suspension, into the mixture of granules and can subsequently be hardened or solidified by suitable measures, e.g. removal of solvents, addition of polymer accelerators, heating for initiating chemical reactions.

According to another embodiment the binder is added to the lightweight granules in solid form, it is converted into the liquid state of aggregation, optionally until a specific viscosity is reached, it is made to penetrate through the bulk material and is subsequently solidified again. Normally, this method is employed such that the mixture of binder/granules is heated until the binder becomes liquid, and it is subsequently cooled again.

A number of suitable binders shall be named in the following. This enumeration is certainly not meant to be complete, but just names by way of example typical representatives of different compound classes which may serve as binders for the lightweight materials according to the invention.

Suitable binders include thermosetting materials, such as epoxy resin, polyurethane, phenolic resin, unsaturated polyester, silicone resin.

Furthermore, thermoplastic materials have turned out to be useful, e.g. polyamide, polyolefin, polystyrene, PVC, polyacetal, thermoplastic polyester.

Furthermore, elastomers may be used as binders; this group of products includes e.g. synthetic rubber, natural rubber, silicone rubber.

Generally, the preferably spherical granules are less heavy than the binders, but granules may also be used that are heavier than the binder on condition that, as far as the characteristics of the material are concerned, emphasis is not laid on its small weight but its high load-bearing capacity together with a high ductility.

For instance, support bearings for heavy machines and for bridges could be produced with success from the material according to the invention by using commercially available balls for roller bearings and PA6 plastic as the components. These bearings are characterized by a high ductility and a very high compressive strength. Deflection rollers for ropes of elevators, alpine railroads, cranes can also be produced according to the invention. Such materials are also suited as supports for houses at risk from earthquakes.

The properties of the lightweight material can be varied by selecting suitable lightweight granules and binders and these can be adapted to the individual demands made on the respective application. It has inter alia been found that the force/displacement diagram can be modified by the structure of the packing. While, for example in the always identical pure plastic matrix of PA 6, a force of 7.5 N/mm² corresponds to a compression of e.g. 8%, the force is 12.5 N/mm² at a packing density of 50% in fine-grained KeraBims and only 1.5 N/mm² in medium-grained KeraPlus. Depending on the selection of the lightweight granules, the compressive strength can thus be increased once by 67%, and another time it can be lowered by 80%. The inventive modification of the characteristics of a plastic material within such a great range is of importance in all accident-prone structural members in all types of vehicles, but also in many other parts of machines and buildings.

In addition, the lightweight materials according to the invention are of excellent economic interest. Since the costs for the mineral filling bodies, based on the volume, are only about 1/10 of those for a binder of plastics, very inexpensive workpieces can be created.

For instance, when the lightweight granules have an amount of 80% by vol. and the plastic binder has an amount of 20% by vol. in the workpiece, the costs for the formulation of the lightweight material are—at a price relation of lightweight granules:plastics of 1:10—only 0.8×1 plus 0.2×10=0.8 plus 2.0=2.8 instead of 10 in a workpiece consisting of 100% plastics. This means that in the workpiece of the present example the costs for the volume formulation are reduced to 72% by employing the invention. The costs of the formulation can even be reduced by 90% by increasing the packing density to 97% and by reducing the amount of plastics to 3%.

This result is of importance for the reason that the weight of the workpiece is additionally reduced by the invention. In the construction of vehicles, the general rule is that a lower weight can only be obtained through higher prices for the material. The workpiece according to the present invention is an exception to this rule:

For instance in the above-mentioned example, the lightweight granules have a density of 110 g/l and the plastic material has a density of 1100 g/l. The weight ratio of lightweight granules to plastic material=1:10. The weight of the workpiece according to the invention as well as the price for the material are reduced by 72% in this example. There are various parts of a comparable function for cars where a check already revealed that the weight could actually be reduced to 25% to 30% of the conventional solutions.

The fact that in the field of lightweight construction where less weight always means higher costs it is even possible to reduce the costs is a very important result of this essential lightweight-material innovation according to the invention .

This result which is surprising for the person skilled in the art is achieved according to the invention by maximizing the amount of the packing on the one hand and by minimizing the use of binders, in particular plastic binders, on the other hand. These two measures taken individually, but particularly together, lead to a progress in materials technology that could so far not be expected.

To the surprise of materials engineers, it could further be detected by way of tests that the material according to the invention has properties that have so far been unknown, inter alia novel rheological properties. Even at very high compressive forces and to the suprise of the experts, the structure of the lightweight granules is maintained upon compression for a long time, e.g. when used as a crash absorber, while the plastic binder is transferred into a flow state and, so to speak, forced to flow through the packing formed by the filling bodies.

According to the invention the rheological properties can be influenced with the special design of the packing. Material combinations with specific compressive strengths and specific surface structures can be created by specific geometrical spatial packings and by lightweight granules, the surface structures being particularly suited for use in workpieces with different functions, such as power absorption by deformation, sound absorption, absorption of bending forces and tensile forces, absorption of compressive forces, etc.

It has e.g. been found in tests that the workpieces according to the invention have not only excellent characteristics as crash absorbers and as other crash-relevant parts of automotive vehicles, but that virtually customized accident-preventing solutions can be compiled with the help of the lightweight materials according to the invention. To the surprise of the experts, accident protection could thus be improved considerably. Lightweight granules with a lower compressive strength have here been chosen, resulting in materials which in comparison with human body parts, e.g. the skull, have lower compressive strengths and thus prevent skull fractures in case of an accident, thereby increasing the chances of survival after an accident.

Finally, thanks to the combination of the inventive materials for crash protection and the inventive materials for the protection of people, workpieces which are suited for the protection of pedestrians could be designed, for instance hoods which depending on the place of impact of the casualty and depending on the dangerous structural members located thereunder (preventing the skull from hitting against hard parts, such as engine, battery, suspension struts) permit a product with customized different compressive strengths.

According to the proposal of the EU Commission for Vehicle Safety (EEVC) rules should be issued for the protection of pedestrians. According to these rules accidents at specific speeds should no longer be deadly for pedestrians. This demand can be met by the present invention through the measure that pads consisting of the lightweight material according to the invention are mounted above engine, battery, suspension struts and other “hard” parts and below the hood, and that the compressive strength of the pads is adjusted such that the demands are met. This is e.g. the case when the compressive strength of pads plus hood is smaller than the compressive strength of the body part hitting thereon. Alternatively, this demand can be met by the measure that the complete hood consists of the lightweight material and that above “hard” parts the thickness of the hood is preferably increased inwards and that it is filled there for the formation of pads with lightweight granules, preferably in the range below 100 g/l, while heavier granules are used in the remaining areas.

The lightweight materials of the present invention can be used as such materials. However, it is also possible to provide these in part or on all sides with surfaces of foils, sheets and extruded hollow sections or other hollow sections of steel, stainless steel, fiber laminates and plastics. Such lightweight materials equipped with surfaces yield workpieces of a very high strength.

A further use of the invention is the reinforcement of frames, in particular vehicle frames, A, B or C pillars, cast parts, in particular very thin-walled large-surface cast parts of aluminum or magnesium, such as lids of luggage trunks, doors, or hoods.

Furthermore, the invention can be used in the production of flat products for use as floors for trains, street lines, buses, caravans and trucks, including trailers. In this instance, the low weight and robustness, crash safety and wear resistance of the material according to the invention are in particular emphasized.

Because of the long life and non-decaying property of the lightweight materials according to the invention, these are also suited for use in the building trade, where constructional members, such as roof subdecking, are of particular interest: These can assume the current functions of roof truss, boarding, roof covering, lathing and/or thermal insulation in a multifunctional way and are, in addition, particularly easy to mount.

A further use of the invention refers to the production of very lightweight and robust concrete formworks for buildings and of scaffolding and the floor boards thereof for the building sector.

Short- or long-fibered reinforcement fibers have turned out to be suited as further components for the lightweight materials according to the invention.

A further subject of the present invention is the provision of a novel composite material. The composite material according to the invention comprises a core of a lightweight material, preferably made from the above-described lightweight material and a surface which surrounds the core completely or in part and consists of steel, stainless steel, fiber laminates or plastics.

As is known, composite materials which contain one or more components of plastics have different thermal expansion properties of the individual components. The properties are due to the different material characteristics of plastics in comparison with metal and other components, For instance, the thermal expansion of plastics is by two powers of ten higher than that of metal. Moreover, plastics are formed at temperatures of more than 200° C. and, when cooled down, show a shrinkage of up to about 10%. These unfavorable characteristics limit the use of the known composite materials.

In contrast to the known composite materials, the composite materials according to the invention have no comparable thermal expansion and, in particular in the case of a lightweight granular amount of 55-90% by vol. in the lightweight material, have thermal coefficients which are in the range of aluminum to steel. The thermal coefficient is here adjustable by the packing density, the grain and packing structure of the lightweight granules.

Furthermore, it has been found that in the case of a packing density of the lightweight granules of 55 to 90% by vol. a shrinking of the plastic matrix is avoided entirely or almost entirely. For instance, when PA6 is cast at a casting and polymerization temperature of about 160° C. without lightweight granules, a shrinkage of 6% is detected, whereas at a packing density of the lightweight granules of 70% by vol. a shrinkage of less than 0.5% is observed.

Since the composite materials according to the invention do not shrink or do almost not shrink, annealing for several hours which is required after the casting process can in most cases be dispensed with. This reduces not only the costs considerably, but permits for the first time the use of casting materials in the mass production of e.g. large car parts on account of the reduction of the production times from 10 to 24 hours to a few minutes.

The lightweight materials according to the invention are produced as follows: introducing the lightweight granules into a workpiece mold, optionally heating the lightweight granular bulk material, introducing the binder into the workpiece mold filled with lightweight granular bulk material, solidifying the binder.

For achieving optimum packing densities, particles of different grain sizes are successively introduced into the mold in such a manner that the operation is started with the largest grain. Subsequently, the second-largest grain is allowed to flow in. Each of these steps is supported by measures for compacting the bulk material.

Suited therefor are e.g. shaking, treatment with ultrasound or vibration and/or use of negative pressure or overpressure.

Each of these measures shortens not only considerably the time needed for filling the mold, but simultaneously increases the packing density to a considerable extent.

As soon as the mold has been filled completely with the lightweight granules of the largest diameter (primary grain), this process is repeated in the case of an additional secondary grain. With the secondary grain the voids created between the primary grains are filled by this process.

It has been found that the process of forming a lightweight granular bulk material can be automated very easily and precisely. Using an additional core binder, it is possible first externally, i.e. not in the workpiece mold proper, to produce infiltration cores consisting of the lightweight granular bulk material. To this end the lightweight granules can already be wetted with a suitable binder prior to core formation. The bound core produced thereby externally is preferably inserted by means of a robot into the workpiece mold and is then infiltrated with the binder in the already described manner.

When the lightweight granules and the binder, respectively, are filled into the workpiece mold, the correct filling speed is of decisive importance. The flow of lightweight granules has to be configured such that a still uniformly flowing filling front is maintained in the mold. Equally, a uniformly flowing filling front is taken as a basis for the configuration of the binder flow.

In the present case a uniformly flowing binder flow is of particular importance for the reason that the binder has a density 10 times higher than the lightweight granules and a binder accumulation would effect a floating of the granules, which might lead to irregularities in the packing.

Preferably, the workpiece mold and/or the lightweight granules and/or the binder are heated before the materials are filled in.

The invention shall now be described with reference to examples and drawings. It is of course not limited to said embodiments.

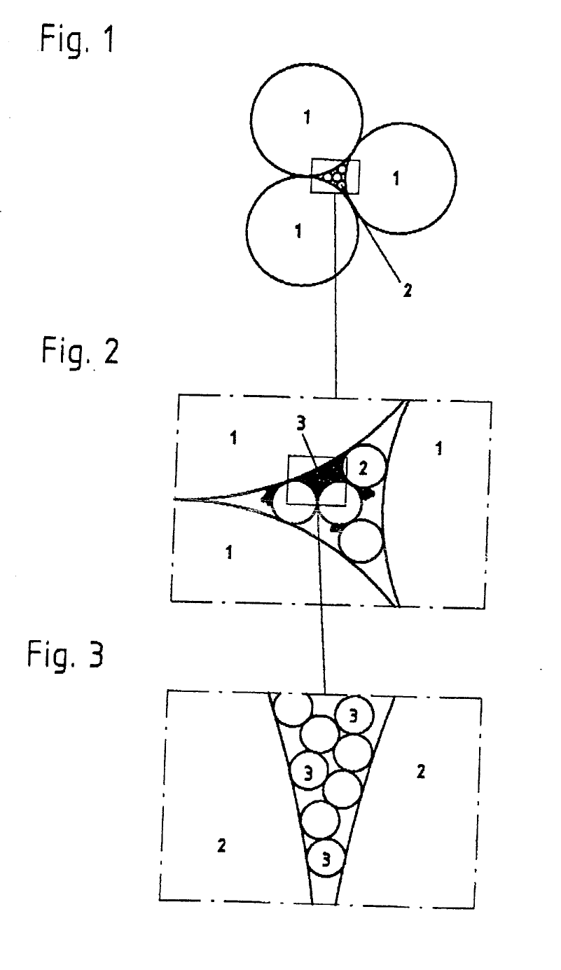

FIG. 1 shows a typical structure of the lightweight material according to the invention with primary and secondary grain;

FIG. 2 shows a typical structure of the lightweight material according to the invention with primary, secondary and tertiary grain;

FIG. 3 is an enlarged sectional view of the lightweight material shown in FIG. 2;

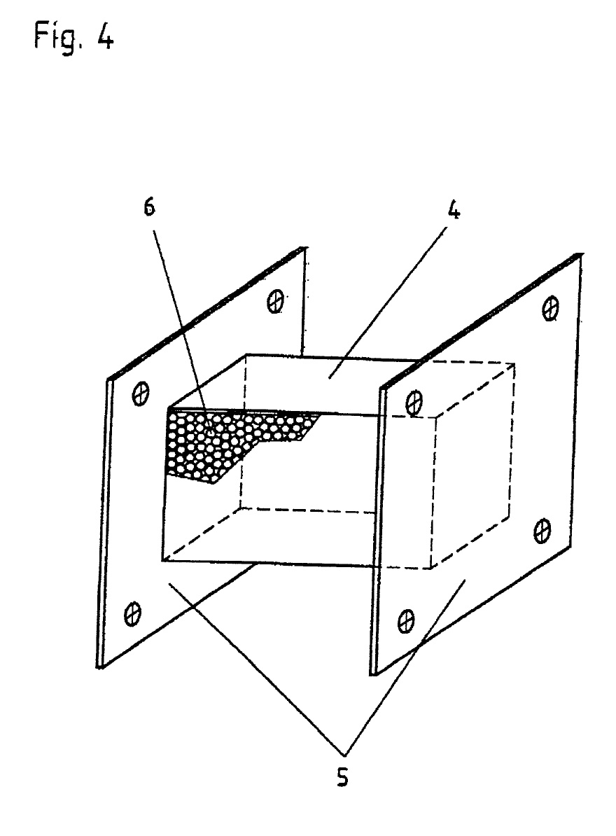

FIG. 4 shows a crash absorber manufacture d by using the lightweight material according to the invention;

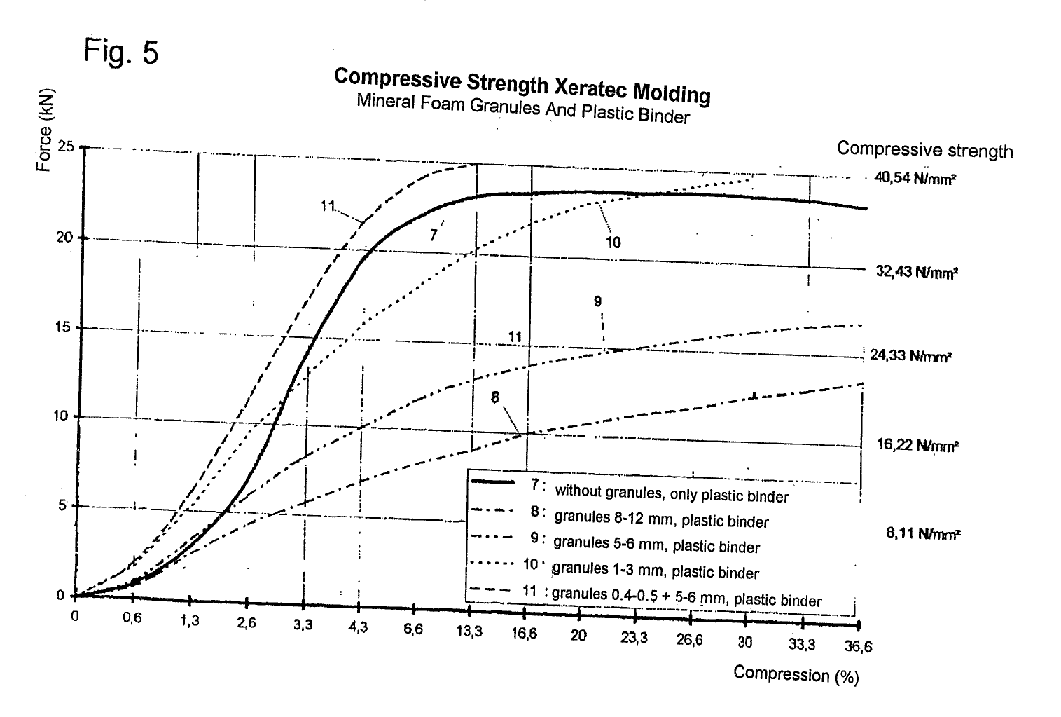

FIG. 5 shows a force/displacement diagram for a plastic material and for various lightweight materials according to the invention;

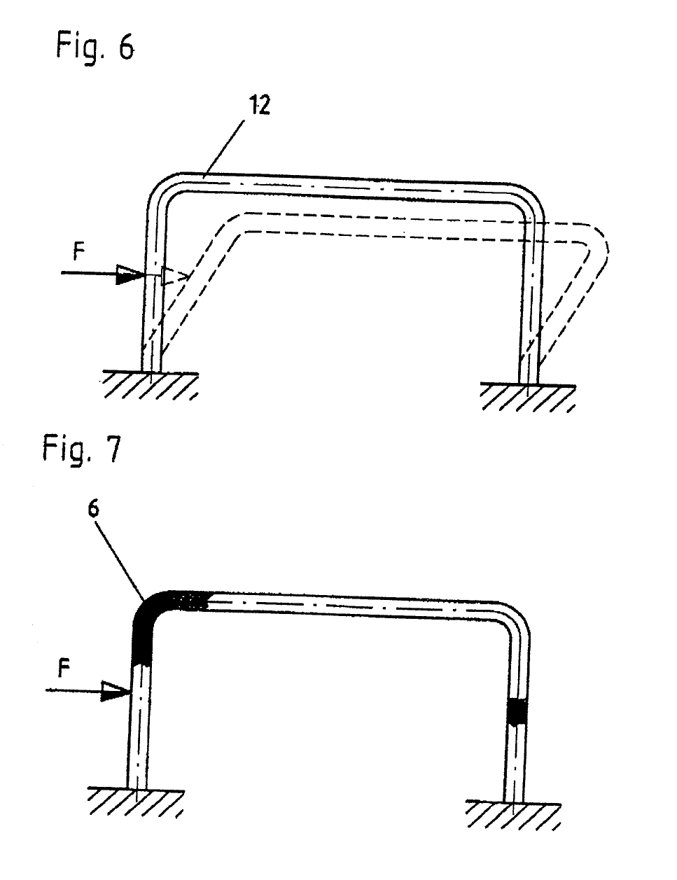

FIG. 6 shows a conventional roll bar for an automotive vehicle;

FIG. 7 shows a roll bar for an automotive vehicle, produced by using the lightweight material according to the invention;

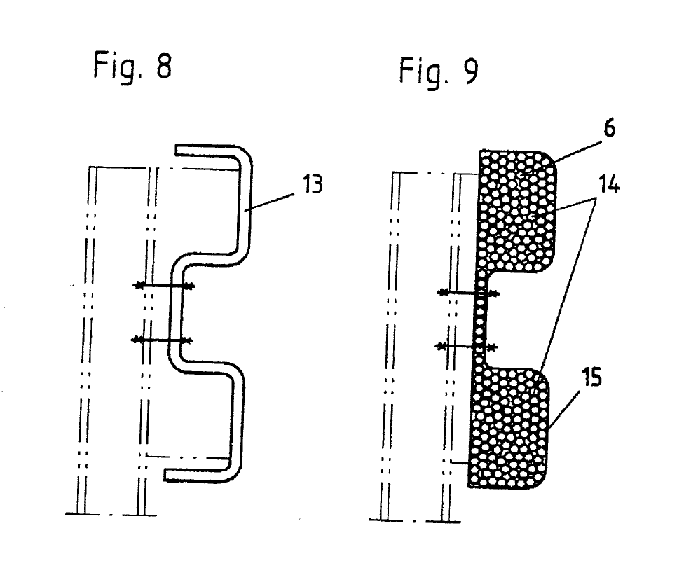

FIG. 8 shows a conventional crash barrier;

FIG. 9 shows a crash barrier produced by using the lightweight material according to the invention;

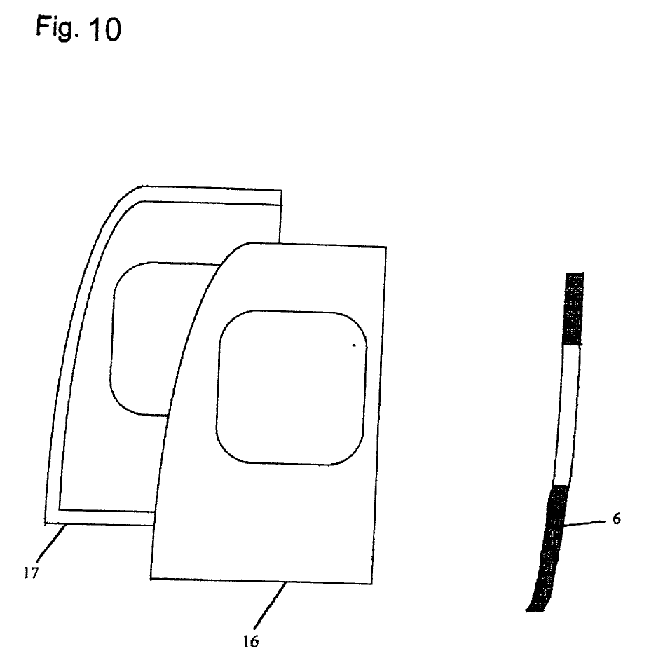

FIG. 10 shows a rear door of a van, produced by using the lightweight material according to the invention;

FIG. 11 shows a wheel cover produced by using the lightweight material according to the invention;

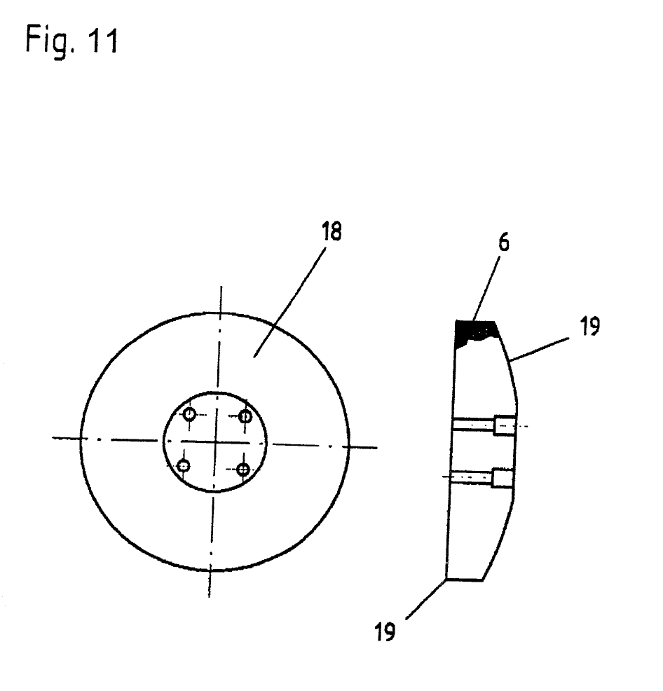

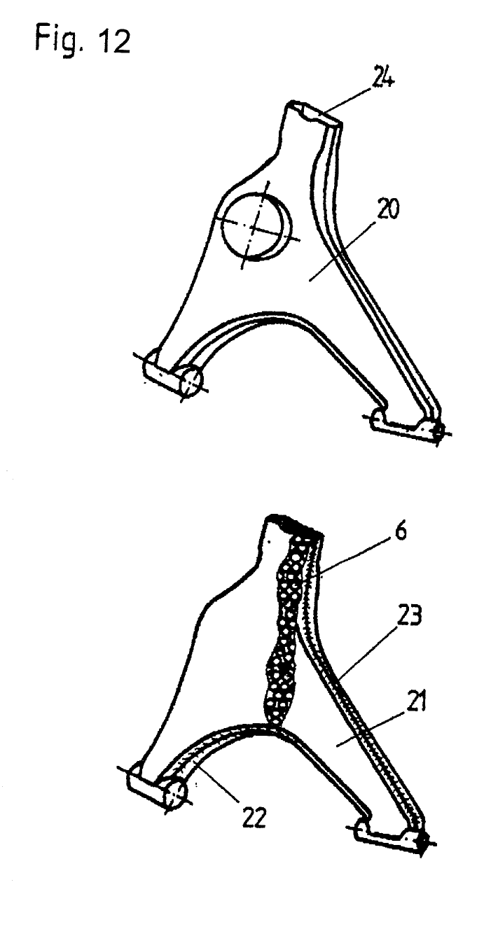

FIG. 12 shows a chassis part of an automotive vehicle, produced by using the lightweight material according to the invention;

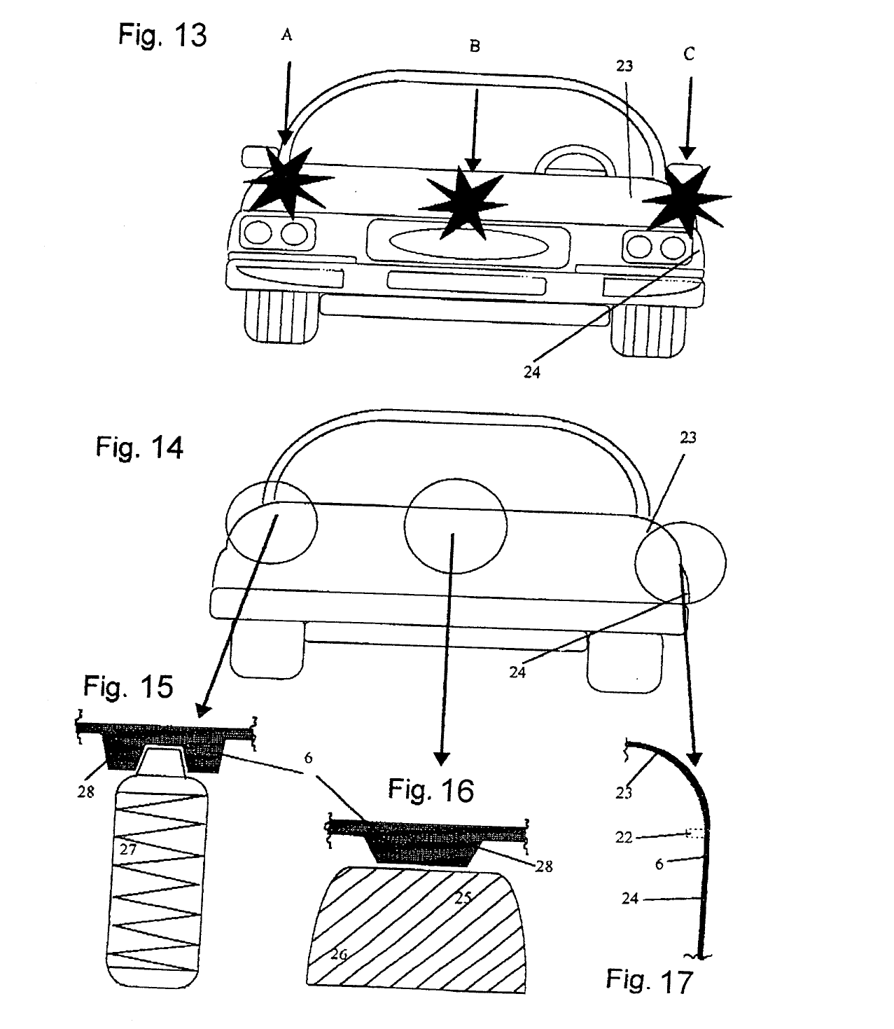

FIG. 13 shows a hood for an automotive vehicle;

FIG. 14 shows a hood for an automotive vehicle, produced by using the lightweight material according to the invention;

FIGS. 15-17 are enlarged views showing specific portions of the hood illustrated in FIG. 14, partly in section;

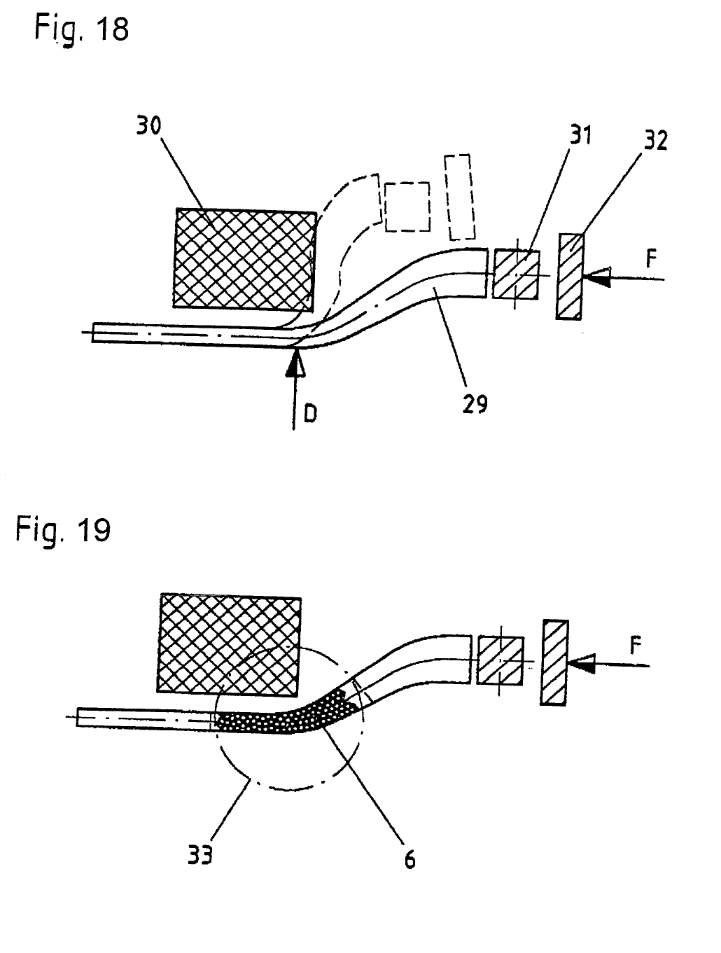

FIG. 18 shows a frame half of a conventional vehicle frame;

FIG. 19 shows a frame half of a vehicle frame, produced by using the lightweight material according to the invention;

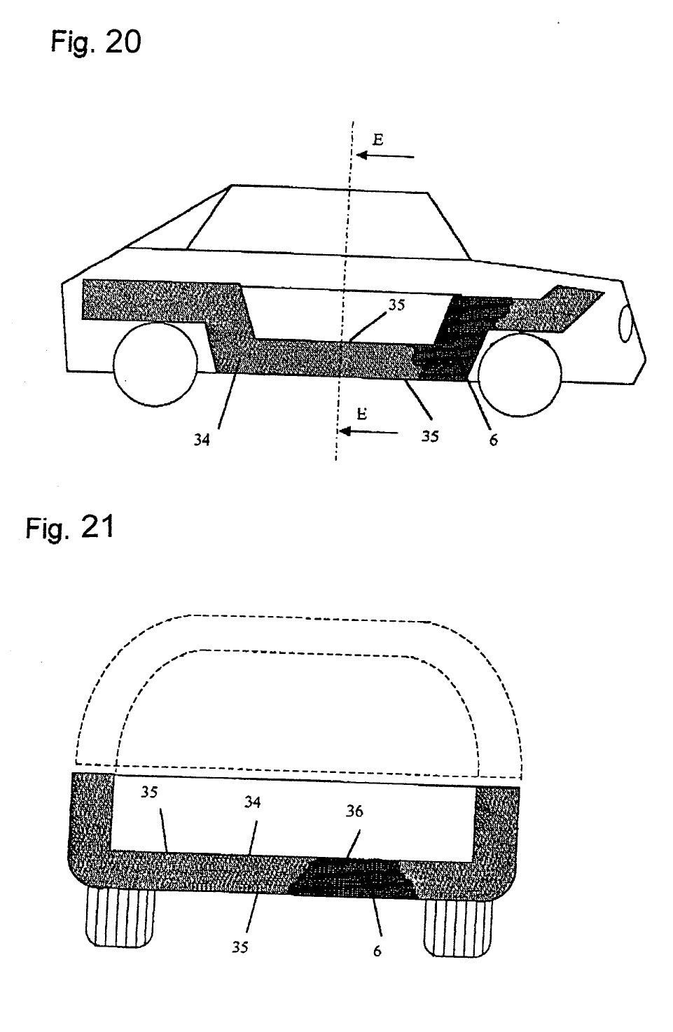

FIG. 20 shows an underbody of an automotive vehicle;

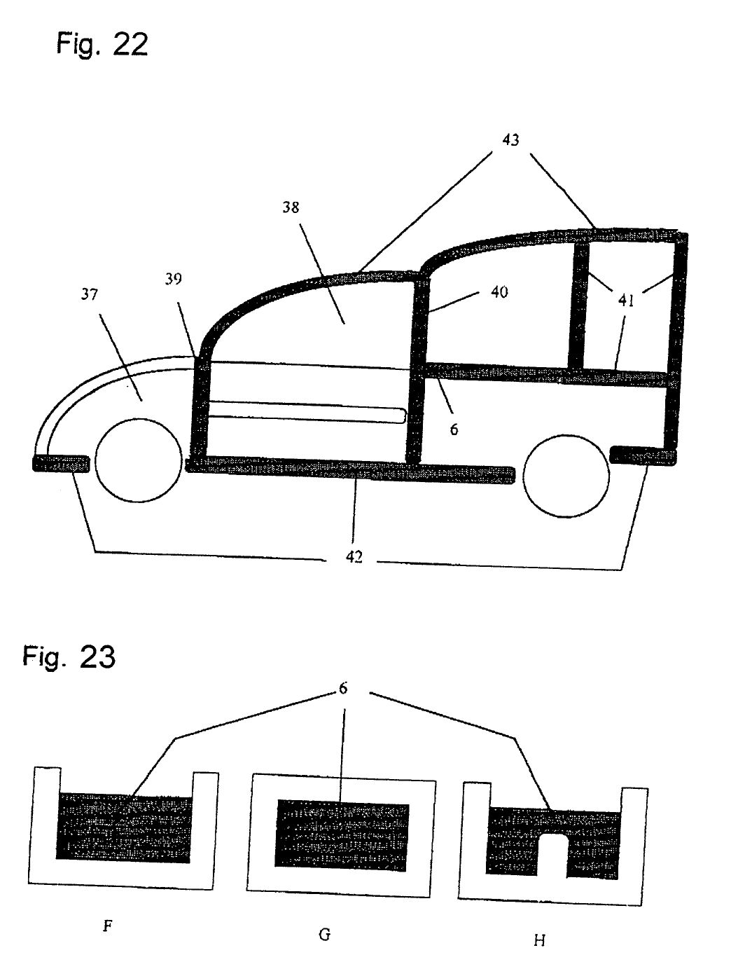

FIG. 21 shows an underbody of an automotive vehicle, produced by using the lightweight material according to the invention;

FIG. 22 shows a side of a van, produced by using the lightweight material according to the invention;

FIG. 23 shows reinforcing measures for the van illustrated in FIG. 22;

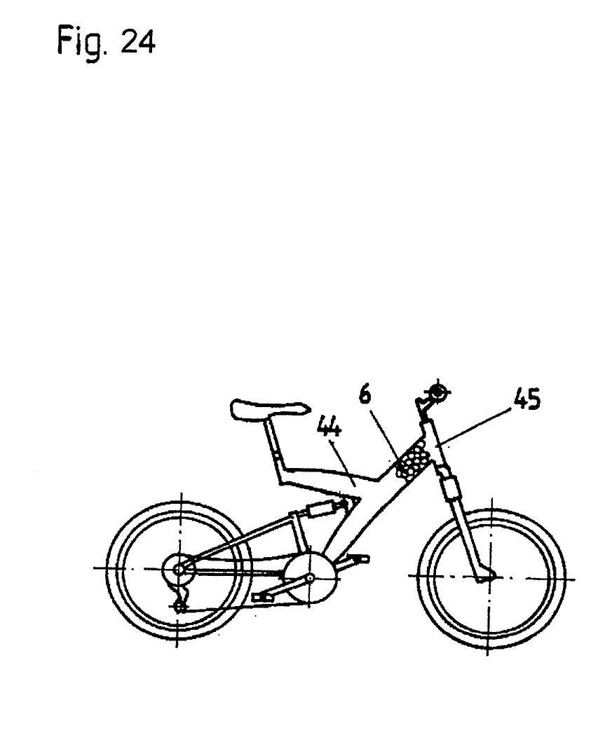

FIG. 24 shows a bicycle frame produced by using the lightweight material according to the invention;

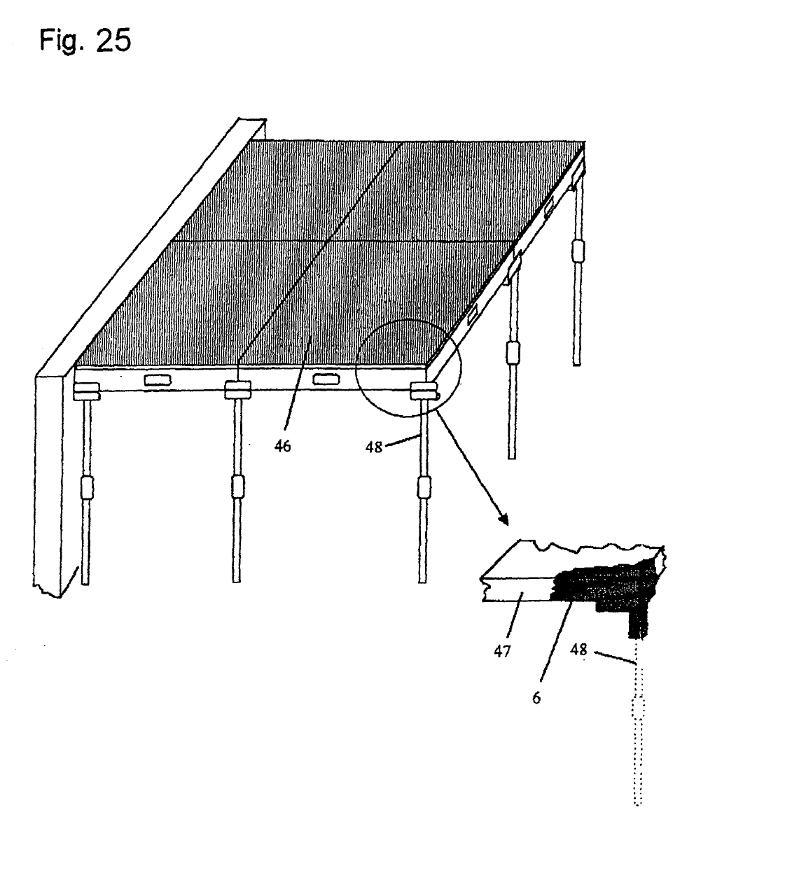

FIG. 25 shows a concrete boarding produced by using the lightweight material according to the invention; and

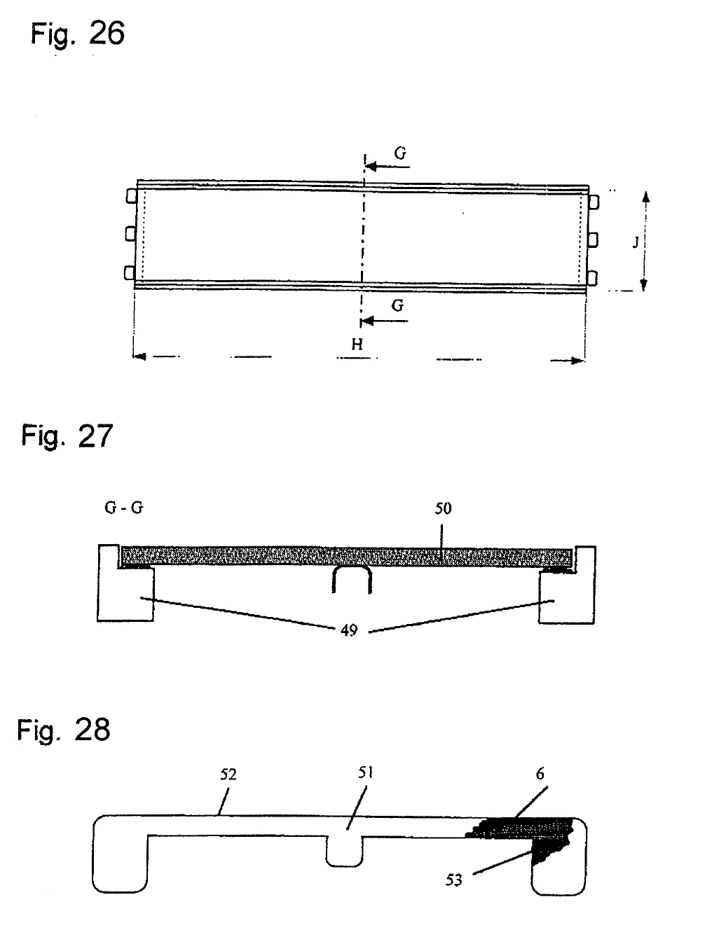

FIGS. 26-28 show parts of a scaffolding, produced by using the lightweight material according to the invention.

The terms as used hereinafter shall once again be defined in the following:

The term primary grain designates the largest grain group of the packing.

Secondary grain designates the second largest grain group of the packing. Tertiary grain designates the third largest grain group of the packing:

The following packing densities can be achieved according to the invention:

| | Description of the packing structure (% by vol.) | Packing density |
|---|---|---|
| 1. | Maximum grain size (primary grain), | 66% |
| | deviation grain size max. +/− 6% | |
| | deviation from the spherical shape +/− 4% | |
| 2. | Like in 1., additionally with secondary grains | 86% |
| | 1/10 of the primary grain size, | |
| | same tolerances | |
| 3. | Like in 2., additionally with tertiary grains | 94% |
| | not more than 1/100 of the primary | |
| | grain size | |
| | same tolerances | |

According to the invention a secondary grain with a grain size between 1/6 and 1/12 of the monogram is used. A possible tertiary grain, in turn, has 1/6 to 1/18 of the grain size of the secondary grain.

An inventive structure of packings according to Examples 1 to 3 in the case of a grain size grading by the factor 1/10 and in the case of grain sizes of 12 mm, 1.2 mm and 0.12 mm yielded the following packing densities:

| Example | | Packing density/plastic amount |
|---|---|---|
| 1. | 66% P-grain | 66% packing + 34% plastic |
| 2. | 66% P-grain + 20% S-grain | 86% packing + 14% plastic |
| 3. | 66% P-grain + 20% S-grain + | 94% packing + 6% plastic |
| | 8% T-grain | |

Moreover, this process may be continued by a quaternary grain.

Of decisive importance to the quality of the lightweight material is the reduced amount of plastics which is achievable through the invention. According to the invention it can be halved by respectively introducing a further sub-grain at a factor 1/10 regarding the grain grading which has turned out to be expedient in practice.

This results in further advantages which so far could not be achieved with respect to lower density and lower prices for the raw material mixture.

The following example was calculated for the following prices, which are average prices at the moment:density:grain 1:110 g/l, grain 2:50 g/l, plastic 1, 100 g/l, prices:granules DM 1.00/l, plastic DM 10.000/l.

| | Density (kg/l) | Density (kg/l) | Raw material price |
|---|---|---|---|
| Example | grain 1 | grain 2 | (DM/l) |
| 1. | 447 | 407 | 4.06 |
| 2. | 249 | 197 | 2.26 |
| 3. | 169 | 113 | 1.54 |

Hence, with a large workpiece, e.g. a crash barrier, a particularly excellent solution is possible by using a very large primary grain and a secondary grain, a tertiary grain and a quaternary grain:plastic amount 3%; density below 0.1 kg/l; price about DM 1.00/l.

As has already been described, the mineral lightweight granules according to the invention have a graded distribution of the grain sizes in the packing. The primary grain is determined according to the geometry of the workpiece and has the largest amount in the volume of the workpiece with preferably more than 50% by vol.

The structure of a lightweight material according to the invention is shown in FIGS. I to 3. FIG. 1 shows the structure of a material produced by using primary grains 1 and secondary grains 2. The packing of the lightweight granules in the material is first defined by the individual round or almost round primary grains 1 which are deposited side by side and one on top or below the other, so that voids are created between the individual grains. The secondary grains 2 are then deposited within said voids to achieve a packing of the lightweight granules in the material that is as dense as possible. It is thereby possible to reduce the binder amount needed because only the voids between the secondary grains and between the secondary and primary grains have still to be filled.

An even denser packing of the lightweight granules is shown in FIGS. 2 and 3. These are granules comprising primary 1-, secondary 2-, and tertiary 3-grains. Starting from the structure shown in FIG. 1, the voids formed between the secondary grains 2 and between the secondary grains 2 and the primary grains 1 are filled with tertiary grains 3. The space available for the binder is thus reduced even further.

The packings formed in this way, which consist of primary and secondary grains or primary, secondary and tertiary grains, are then infiltrated in a structurally dense manner by plastic material of a high flowability.

In automotive vehicles, crash absorbers with a defined or even variable force/displacement characteristic can e.g. be realized with the material according to the invention for the first time.

FIG. 4 shows such a crash absorber installed between the bumper and the frame of an automotive vehicle. As shown in FIG. 4, it can be made from a round or rectangular covering surface 4 with flanges 5 and a filling consisting of the lightweight material 6 according to the invention. Alternatively, it would also be possible to produce the whole crash absorber from the material according to the invention.

FIG. 5 is an exemplary force/displacement diagram based on tests with the material according to the invention. Depending on the structure of the packing of the lightweight granules in the material according to the invention, different displacement/force conditions can be set in dependence upon the compression solely by way of the packing structure.

Curve 7 shows the behavior of the plastic material without the addition of lightweight granules; this curve serves as a reference curve. Curve 8 can be obtained when the plastic material used for curve 7 is filled with lightweight granules in the grain size range of 8 to 12 mm. As can be seen, the compressive force in a relatively large primary grain is smaller than in an unfilled plastic material. The values shown in curve 9 can be obtained when the reference plastic is filled with lightweight granules of the grain size 5 to 6 mm. In comparison with curve 8, a distinct increase in the compressive force is here noted. As shown in curve 10, a further increase in the compressive force can be achieved by using lightweight granules having a grain size of 1 to 2 mm.

Finally, curve 11 is a force/displacement curve which is obtained when use is made of a lightweight granular combination of primary grains of the grain group 5 to 6 mm and of secondary grains of the grain group 0.5 to 0.6 mm. This result demonstrates that the lightweight material according to the invention enables one skilled in the art to produce—at will and by changing the lightweight granular packing—materials which have both a smaller and higher compressive force than the unfilled reference plastic.

Thus FIG. 5 shows that the compressive strength can be modulated to a considerable extent by varying packing density and grain group composition. FIG. 5 also illustrates that in the range of a low compression the lightweight material according to the invention can reduce the mostly undesired tendency of plastics to creep under load to about half the creep path under comparable conditions. This is an essential advantage of the present invention. The creep path can also be reduced considerably within the range of a very high specific load thanks to the packing structure. The possibility of reduction is here only limited by the grain strength. Hence, the invention makes it possible to use bodies with very high compressive strengths, e.g. balls of ball bearings for producing virtually non-creeping plastics and natural rubbers.

Furthermore, for the first time the whole vehicle or at least part of the vehicle can be built and designed with the inventive lightweight material in such a manner that all or almost all parts of the vehicle take part in energy absorption, thereby contributing to a considerably improved protection from accidents. This energy absorption is effected by the flow of the ductile plastic matrix between the spherical lightweight granules. Consequently, the plastic material behaves likes a dampening liquid of a very high viscosity.

The possibilities resulting from the energy-absorbing lightweight material according to the invention shall be explained in more detail with the help of the following examples:

Buses, trucks, tractors and off-road vehicles are prone to overturn because of their high centers of gravity. Lightweight roll bars can be produced for them with the material according to the invention, said roll bars surpassing by far the former constructions with respect to safety against buckling, but do not entail any increase in vehicle weight and center of gravity.

FIGS. 6 and 7 show a roll bar 12 for an off-road vehicle. FIG. 6 shows a commercially available roll bar 12 which is not reinforced by the lightweight material according to the invention. This bar cannot withstand force “F” in case of an accident and is deformed—e.g. during roll-over of the vehicle—to such a degree that protection of the passengers is no longer guaranteed. By contrast, FIG. 7 shows a bar 12 which has been reinforced with the lightweight material 6 according to the invention and which withstands force “F”. A buckle-proof and very lightweight roll bar is here created by combining a thin outer tube of a high-strength metal and a filling of the same with the lightweight material according to the invention.

In the case of stationary traffic means, such as crash barriers, bridge rails or other boundary means, e.g. also in airports, solutions can be realized with the lightweight material of the invention that considerably improve the prior art. For instance, crash barriers of steel have the advantage on the one hand that they can absorb energy, but have the drawback on the other hand that they cannot guide the vehicle in a reliable manner but, quite to the contrary, fling it back onto the lane. Although crash barriers of concrete do not have this drawback of flinging back the vehicle, they cannot absorb energy. Crash barriers made from the material according to the invention can fulfill both functions, i.e. energy absorption and vehicle guidance, for the first time and at reasonable costs.

FIG. 8 shows a conventional crash barrier 13 as is used in today's traffic. This crash barrier consists of a galvanized sheet steel having a thickness of 3 mm. FIG. 9 shows a crash barrier 14 produced by using the lightweight material 6 according to the invention. This crash barrier comprises a skin 15 of metal or plastics having a thickness of only about 0.5 mm, and a core consisting of the lightweight material 6 of the invention with a very high packing density and a very high energy-absorbing capacity. A crash barrier constructed in this way can guide vehicles without flinging them back. Furthermore, the barrier is obtuse at the front side and does not tend to rip open heavy vehicles, such as buses.

Furthermore, FIG. 10 shows a rear door of a van. The hollow space between outer shell 16 and inner shell 17 is here filled with the lightweight material 6 according to the invention. Stiffening installations which have so far been necessary can thus be dispensed with. The door according to the invention does not tend to drone because it is well cushioned by the lightweight material. Furthermore, it provides an improved protection against crashes.

FIG. 11 shows a wheel cover 18 which apart from its decorative function fulfills the function of providing protection from accidents. The wheel cover consists of a decorative shell 19 and a core 6 consisting of the lightweight material according to the invention. Pedestrians who in case of an accident would otherwise hit against the rotating nuts or against another uneven portion of a wheel can be protected by this configuration of the wheel cover from injuries.

FIG. 12 shows a chassis part 20 of an automotive vehicle that has been filled with the lightweight material according to the invention. Such parts are made in the prior art from sheet-metal shells 21, 22 which are interconnected via a weld seam 23. It is necessary because of the resistance to buckling to over-dimension the sheet-metal shells. The remaining hollow space intensifies droning noise, which requires secondary dampening measures.

In the constructionally identical embodiment using the lightweight construction material of the invention, i.e. with a filling of the lightweight construction material, it is possible to achieve a smaller wall thickness and to reduce the weight of the chassis part at the same time, and to efficiently silence noise. FIG. 12 also shows the joints 23 of the chassis part which is filled according to the invention with the lightweight material 6 via opening 24.

FIG. 13 shows an exemplary embodiment of a hood of an automotive vehicle. The three arrows A, B, C mark the places which are the most dangerous ones for a passer-by during a possible impact, i.e. the positions against which a pedestrian might hit “hard”. Arrow A marks the danger posed by a suspension strut which upon impact of a head may result in damage as a “hard” resistance. Arrow B indicates the position of the “hard” resistances engine and battery. Furthermore, arrow C designates the hard resistance at the transition between hood and fender. Further hard resistances are offered by the inner metal reinforcements of the hood.

To eliminate these considerable sources of risk, FIGS. 14 to 17 show, partly in section, a possible embodiment of the hood using the present invention. The hood and preferably also the fender are completely made from the lightweight material 6 according to the invention without constructionally required reinforcements 22 and are provided, if desired, with a decorative surface consisting e.g. of a metal foil. Hood 23 and fender 23 are manufactured from the material according to the invention with a mean compressive strength.

In the hood, crash pads 28 of the lightweight material of the invention with a low compressive strength are integrated, in particular, at the designated dangerous places, e.g. above the engine 25 or the battery 26 or above the suspension strut 27. The increased wall thickness of the parts, preferably ranging from 3 to 6 mm, which is made possible by the low weight according to the invention ensures an excellent basic energy-absorbing capacity upon impact of a pedestrian and permits, moreover, to design the transition between hood 23 and fender 24 without edge reinforcements 22 or only with small wall reinforcements, whereby a further place of a possibly strong resistance is eliminated. Moreover, according to the invention the transition is designed closer to the ground in comparison with the prior art, whereby it is no longer located in the area of a possible impact. For instance, the traffic safety of an automotive vehicle can also be guaranteed for pedestrians by the invention. Moreover, such a hood produced by using the material according to the invention has a considerably lower weight than comparable hoods made from steel sheet.

FIG. 18 shows a frame half 29 in the front area of an automotive vehicle. This frame carries, on the one hand, the engine 30 as well as other units and holds, on the other hand, the crash absorber 31 and the front bumper 32 and further front parts of the automotive vehicle. The height of the frame below the engine and thus its moment of resistance are limited by the dimensions of the engine 30. Arrow D in FIG. 18 marks the critical place. A crash would have the consequence that the front part of the frame is not deformed in an energy-absorbing way, as is desired, but that it its bent towards the engine, possibly displacing the engine even into the passenger compartment.

FIG. 19 shows how this weak point was eliminated by a local filling 33 of the frame with the lightweight material 6 according to the invention.

FIGS. 20 and 21 further show an underbody of an automotive vehicle. According to the prior art underbodies consist of a multitude of steel sheets which are joined by automatic welding machines. When the material of the invention is used, the underbody 34 consists of thin connected shells 35 and 36 of metal or plastics and a core of the lightweight material 6 according to the invention.

Both the chassis and all units, the seats, etc., can directly be accommodated by the underbody. The underbody is reinforced accordingly at said places. It is furthermore shaped such that it affords maximum protection from accidents by laterally combining, like a crash barrier, the energy-absorbing capacity with the capacity of discharging the colliding object and by ensuring a high stiffness of the whole underbody.

FIG. 22 shows the side 37 of a conventional van. Vans of this type are mounted on passenger car platforms which as a rule are not prepared for the additional weight. Therefore, the lightweight construction in vans is of utmost importance. FIG. 22 shows how, inter alia in the area of the A-pillar 39, the B-pillar 40, the box body 41, the underbody 42 and in the roof area 43, reinforcing measures can be taken, as illustrated in FIG. 23 as F, G, H, by using the material according to the invention. These reinforcing measures permit a lightweight construction in the area of the metal components, thus resulting in a reduction of the weight.

FIG. 24 shows the frame 44 of a sport mountain bike. In the conventional type of a welding construction of aluminum, the aluminum frame has a weight of 4.5 kg. This is very high for a device for competitive sports. Nevertheless, the protection provided in the steering head 45 against fracture is inadequate. The frame weight of 4.5 kg could be reduced to 0.99 kg and thus by 78% by using very thin welded aluminum shells and by filling the hollow space with the lightweight material according to the invention.

FIG. 25 shows a concrete formwork for a ceiling. The ceiling shuttering rests on a frame 48. The known concrete shuttering consists of a laminated wood 46 with a surface sealing. Before every use the laminated wood must be treated with a mold oil. The service life is limited to about 20 uses due to swelling. A plate 47 of the same thickness consisting of the lightweight material 6 according to the invention does not require a mold oil and does not show any life-limiting wear even after 50 uses.

Furthermore, FIGS. 26, 27, 28 show parts of a scaffolding. FIG. 26 is a top view on the scaffolding floor having a length H and a width J. FIG. 27 shows a cross-section through said floor, consisting of a metal frame 49 and a floor board of solid wood 50. This board has a weight of 20.4 kg at a dimension of 2.57×0.61 m.

Furthermore, FIG. 28 shows a scaffolding floor made by using the material according to the invention, comprising surfaces 52 and a core of the lightweight material 6 according to the invention. At the same dimension this board has a weight of only 7.6 kg. It is important because of the manual labor required for assembly and disassembly that scaffolding floors have a very low weight. The weight reduced by ⅔ facilitates work and makes the assembly much cheaper.

In the following, a possible production of a lightweight construction material of the invention is described by way of example with two different grain size groups.

The following starting components were here used:

mineral foam granules: primary grain with a grain size of 56 mm ±4%

mineral foam granules: secondary grain with a grain size of 0.4-0.5 mm ±4%

plastic binder: PA 6 liquid component

First of all, the primary grain feed was filled into the filling opening of a closed cylindrical mold (Ø80 mm, height 400 mm, corresponding to 2.0 liter) without additional compaction. The volume amount of the primary grain was 64.15%. The volume amount was raised to 68.50% by exerting a shaking movement on the cylindrical mold with the help of a vibrating table.

Subsequently, the secondary grain feed was filled into the filling opening of the cylindrical mold without compaction. The volume amount of the secondary grain was 22.50%, the filling time 5.1 min. Subsequently, a shaking movement was again carried out for 2.15 min, resulting in a volume amount of 24.50% and, under the action of a negative pressure (150 Pa) for 2.15 min, in a volume amount of 24.48% by vol. Due to the shaking movement and the action of negative pressure it is possible to deposit the secondary grain in the voids which are created in the first step of the process between the primary grains, so that this step contributes to a considerable compaction of the granular material.

Subsequently, the grain feed was heated in the mold to 150° C. and the liquid component PA6 (viscosity 3-5 mPa, after admixture of the activator) was filled in as plastic binder (reaction temperature 130° C.) for the bulk material. The filling operation was here effected by way of gravity. The filling time was 4 minutes, the volume amount of the binder 13.35%. For further compaction a shaking movement with gravity action was carried out for 2.15 min. A volume amount of 7.0% was thereby achieved. Subsequently, a negative pressure of 150 Pa was additionally exerted by suction on the cylinder bottom for a better penetration of the bulk material. This process was carried out for 2.10 min and did not result in a change in the volume amount. The liquid exiting at the bottom control opening showed that the bulk material was completely filled.

The reaction time for the polymerization was 3 min. Subsequently, the lightweight material was removed from the cylindrical mold.

The material sample obtained in this way had the following values:

| | | |
|---|---|---|
| bulk density: | 0.41 | g/cm³ |
| compressive strength: | 9 | N/mm² at 2% compression |
| | 40 | N/mm² at 10% compression. |

By comparison the values of the material of a comparative body of plastics (PA6) are as follows:

| | | |
|---|---|---|
| bulk density: | 1.13 | g/cm³ |
| compressive strength: | 5 | N/mm² at 2% compression |
| | 38 | N/mm² at 10% compression |

1. A lightweight material containing lightweight granules, in particular mineral foam granules, and an organic binder, characterized in that
the volume amount of the lightweight granules in the material is at least 50% and that the components in the material are bound in a structurally dense manner.

2. The lightweight material according to claim 1, characterized in that the volume amount of the lightweight granules in the material is at least 80%.

3. The lightweight material according to claim 1, characterized in that the volume amount of the lightweight granules in the material is at least 90%.

4. The lightweight material according to any one of claims 1 to 3, characterized in that the lightweight granules consist of flowable, substantially spherical particles.

5. The lightweight material according to at least one of claims 1 to 4, characterized in that the grain size of the lightweight granular particles is between 0.01-30 mm, preferably between 0.04-16 mm, particularly preferably between 0.2 and 8 mm.

6. The lightweight material according to at least one of claims 1 to 5, characterized in that the lightweight granules have a bulk density of 0.040 to 0.600 kg/l, preferably 0.040 to 0.300 kg/l, and a surface porosity of less than 15%, preferably less than 5%.

7. The lightweight material according to at least one of claims 1 to 6, characterized in that the spherical lightweight granular particles substantially have a single grain size group.

8. The lightweight material according to at least one of claims 1 to 6, characterized in that the lightweight granules consist of spherical particles having two different grain size groups.

9. The lightweight material according to claim 8, characterized in that 60-70% by vol. of the lightweight granular particles have a larger grain diameter and 30-40% by vol. a smaller grain diameter.

10. The lightweight material according to claim 8 or 9, characterized in that the diameter of the lightweight granular particles with the larger grain diameter is 6 to 12 times, preferably 10 times, the diameter of the lightweight granular particles with the smaller grain diameter.

11. The lightweight material according to any one of claims 8 to 10, characterized in that the lightweight granular particles of the smaller grain size group are arranged in voids created between the lightweight granular particles of the larger grain size group.

12. The lightweight material according to at least one of claims 1 to 6, characterized in that the lightweight granules consist of spherical particles including three different grain size groups.

13. The lightweight material according to claim 12, characterized in that the lightweight granular particle mixture comprises at least 50% by vol. of particles with a large grain size, not more than 35% by vol. of particles having a medium grain size and not more than 15% by vol. of particles having a small grain size.

14. The lightweight material according to claim 12 or 13, characterized in that the diameter of the lightweight granular particles with the large grain size is 6 to 18 times, at least 12 times, the diameter of the lightweight granular particles with the medium grain size, and the diameter of the lightweight granular particles with the medium grain size is 6 to 18 times, at least 12 times, the diameter of the lightweight granular particles with the small grain size.

15. The lightweight material according to any one of claims 12 to 14, characterized in that the lightweight granular particles of the medium grain size group are arranged in the voids created between the lightweight granular particles of the larger grain size group, and that the lightweight granular particles of the small grain size group are arranged in voids created between the lightweight granular particles of the medium grain size group and the medium and the larger grain size group.

16. The lightweight material according to at least one of claims 1 to 6, characterized in that the lightweight granules consist of spherical particles with more than three different grain sizes, the particles with the smallest grain size having a diameter ranging from 0.030 to 0.150 mm, and the grain size grading is carried out according to the usable grain with the maximum size in such a manner that a grading is carried out each time by the same factor with a tolerance of ±20%.

17. The lightweight material according to at least one of claims 1 to 16, characterized in that the lightweight granules are selected from the group consisting of alkali silicates, alkali/alkaline-earth silicates, alumosilicates, borosilicates, variants in the ternary system CaO—SiO₂—Al₂O₃ in combination with additional metal oxides.

18. The lightweight material according to any one of claims 1 to 16, characterized in that the lightweight granules are aluminum oxide or sodium silicate.

19. The lightweight material according to any one of claims 1 to 18, characterized in that two or more different lightweight granules are optionally contained in different volume amounts.

20. The lightweight material according to any one of claims 1 to 16, 19, characterized in that the lightweight granules are a metal or another non-mineral material.

21. The lightweight material according to any one of claims 1-20, characterized in that the organic binder is capable of flowing and consists, in particular, of a liquid or a flowable powder.

22. The lightweight material according to claim 21, characterized in that the organic binder is a thermosetting material.

23. The lightweight material according to claim 22, characterized in that the thermosetting material is selected from the group consisting of epoxy resin, polyurethane, phenolic resin, unsaturated polyester, silicone resin.

24. The lightweight material according to claim 21, characterized in that the organic binder is a thermoplastic material.

25. The lightweight material according to claim 24, characterized in that the thermoplastic material is selected from the group consisting of polyamide, polyolefin, polystyrene, PVC, polyacetal, thermoplastic polyester.

26. The lightweight material according to claim 21, characterized in that the organic binder is an elastomer.

27. The lightweight material according to claim 26, characterized in that the elastomer is selected from the group consisting of synthetic rubber, natural rubber, silicone rubber.

28. The lightweight material according to at least one of claims 1 to 27, characterized in that short- or long-fibered reinforcing fibers are contained as further component.

29. The lightweight material according to at least one of claims 1 to 28, characterized in that the lightweight material is provided in part or on all sides with a surface consisting of another material.

30. The lightweight material according to claim 29, characterized in that the surface consists of steel, stainless steel, fiber laminates or plastics.

31. A composite material comprising a core consisting of a lightweight material, preferably according to any one of claims 1 to 28, and a surface surrounding the core completely or in part and consisting of steel, stainless steel, fiber laminates or plastics.

32. The composite material according to claim 31, characterized in that the lightweight material contains 55 to 90% by vol. of lightweight granules.

33. A method for producing the lightweight material according to any one of claims 1 to 28, characterized by the following steps:
introducing the lightweight granules into a workpiece mold,
optionally heating the grain feed of lightweight granules,
introducing the binder into the workpiece mold filled with the lightweight granular bulk material,
solidifying the binder.

34. The method according to claim 33, characterized in that the lightweight granular particles with the largest grain size are first filled in and then, with a decreasing size, one grain size after the other.

35. The method according to claim 34, characterized in that the process of forming the lightweight granular bulk material is supported by shaking, vibration, ultrasound and/or by applying a negative pressure.

36. The method according to claim 34, characterized in that after the lightweight granular particles of a specific size have been filled in, the process is supported by shaking, vibration, ultrasound and/or by applying a negative pressure, and it is only subsequently that lightweight granular particles of a smaller grain size are filled in.

37. The method according to any one of claims 33 to 36, characterized in that the filling in of the binder is supported by shaking, vibration, ultrasound, overpressure or negative pressure.

38. The method according to any one of claims 33 to 37, characterized in that the volume flow of lightweight granules is configured such that an evenly flowing filling front can be maintained in the mold.

39. The method according to any one of claims 33 to 38, characterized in that an evenly flowing binder-filling front is maintained in the mold.

40. The method according to any one of claims 33 to 39, characterized in that the workpiece mold is heated prior to filling.

41. The method according to any one of claims 33 to 40, characterized in that the lightweight granules are heated prior to being filled into the workpiece mold.

42. The method according to any one of claims 33 to 41, characterized in that the binder is heated prior to being filled into the workpiece mold.

43. The method according to any one of claims 33 to 42, characterized in that the resulting lightweight granular bulk material is bound with a core binder to produce an infiltration core.

44. The method according to any one of claims 33 to 43, characterized in that prior to the filling operation the lightweight granules are wetted with a binder by which the lightweight granular bulk material is bonded to form an infiltration core.

45. The method according to any one of claims 43 and 44, characterized in that at first only an infiltration core of lightweight granules bound with a porous bulk material is produced, the core is removed from the mold, and the binder is filled at another time into the core which is again introduced into a workpiece mold.

46. An infiltration core formed according to the method according to claim 45.
